(19) United States
(12) Patent Application Publication
(10) Pub. No.: US 2009/0229321 A1
(43) Pub. Date: Sep. 17, 2009

(54) Lock Assembly

(75) Inventors: Nicholas Eccles, Chicago, IL (US); Dickory Rudduck, Chicago, IL (US); John Freese, Evanston, IL (US); Benjamin David Ford, Chicago, IL (US); Paul Kudrna, Naperville, IL (US); Cary Maguire, Chicago, IL (US); David Kazmierz Szczypinski, Chicago, IL (US); Michael Kondratuk, Brookings, SD (US)

Correspondence Address: TELEZYGOLOGY, INC., 520 W. ERIE STREET, SUITE 210, CHICAGO, IL, 60654, US

(73) Assignee: Telezygology, Inc., Chicago, IL (US)

(21) Appl. No.: 12/397,421

(22) Filed: Mar. 4, 2009

Related U.S. Application Data
(60) Provisional application No. 61/033,936, filed on Mar. 5, 2008.
(60) Provisional application No. 61/051,047, filed on May 7, 2008.

(51) Int. Cl. E05B 65/04; E05B 49/00; E05B 47/02; G05B 19/02

(52) U.S. Cl. 70/93; 70/278.1; 70/277; 70/91; 340/825.22

(57) ABSTRACT

The invention provides a lock assembly (10) which has a support base (80) and a bolt (14) movable between an unlocked position, in which the bolt (14) is substantially within the support base in (80) and a locked position in which the bolt (14) extends from the support base (80). The lock assembly (10) also includes locking means (32) to block movement of the bolt (14) in the locked position and actuating means (46) for moving the blocking means (32) to release the bolt (14) from the locked position. The actuating means (46) can comprise electromechanical means, an electro restrictive polymer, piezoelectric material or a material adapted to contract when activated, such as shape memory alloy wire (36).

### CROSS-REFERENCE TO RELATED APPLICATIONS

This application claims priority from earlier filed U.S. provisional applications: 61/033,936 filed on Mar. 5, 2008 and 61/051,047 filed on May 7, 2008.

### BACKGROUND OF THE INVENTION

1. Field of the Invention

This invention relates to a lock assembly. More particularly, the invention relates to a lock assembly with electronic locking features.

2. Description of Related Art

Electronic lock assemblies are commonly useful in door applications and the like. The door can be locked and unlocked by input of an entry code or by other authorisation, such as a biometric identification or even a key.

It is desirable to have an easy and relatively simple assembly for an electronic lock assembly, in particular, having an electronically activated blocking means.

It is therefore an object of the present invention, at least in one aspect, to provide an electronic lock assembly with an electronically activated blocking means which is easy to assemble and cost efficient.

This and other objects of the invention will be apparent from the following description. At the very least, the invention provides an alternate arrangement to presently known electronic lock assemblies.

### BRIEF SUMMARY OF THE INVENTION

According to the present invention, there is provided a lock assembly including a support base, a bolt moveable between an unlocked position in which the bolt is substantially Within the support base and a locked position in which the bolt extends from the support base, blocking means to block movement of the bolt in the locked position and actuating means for moving the blocking means to release the bolt from the locked position, the actuating means comprising electromechanical means, an electro restrictive polymer, piezoelectric material or a material adapted to contract when activated.

The lock assembly of the invention may have a single bolt or may include, as well as the bolt, a tongue or latch. When the lock assembly of the invention includes a tongue or latch as well as the bolt, the lock assembly can be mounted on a door or the like to provide a passage function when the bolt is in the unlocked position. Such a latch or tongue may be operated by a handle rotatable in relation to the support base, in known manner. When the lock assembly of the invention does not include such a separate tongue or latch, it is preferred that the bolt can be operated by a handle rotatable in relation to the support base, when the bolt is not blocked in the unlocked position by the blocking means. The bolt may also function as a latch in the unlocked position. In either case, optionally, the handle may be biased to a predetermined position by suitable means such as a compression spring.

It is preferred that the bolt is biased to the locked position by a spring or other suitable biasing means.

The bolt may take any suitable form. The bolt may be a dead bolt or a live bolt. Preferably, the dead bolt form is used when the lock assembly includes a latch or tongue and the live bolt form is used when there is no separate latch or tongue.

In one preferred embodiment, the bolt includes one or more cavities to cooperate with the blocking means. In a different preferred embodiment, the bolt is of conventional design, with the blocking means operating differently.

The support base may take any suitable form. Preferably, the support base includes at least one backing plate to support some or all of the components of the lock assembly of the invention, as well as a second plate, preferably at right angles to the backing plate. The second plate in this embodiment has an aperture through which the bolt extends in the locked position. Where the lock assembly of the invention includes a tongue or latch, the second plate preferably has a second aperture through which the tongue or latch can extend.

The blocking means is adapted to hold the bolt in the locked position. In one embodiment, the bolt includes a cavity and the blocking means is adapted to at least partially enter the cavity so as to prevent the bolt moving to the unlocked position. In another embodiment, the blocking means takes the form of a catch which, when the bolt is in the locked position, blocks a lever which would otherwise retract the bolt from the locked position. Other configurations are possible. It is preferred that the blocking means is biased towards the position where it holds the bolt in the locked position.

The actuating means for moving the blocking means to release the bolt from the locked position includes electromechanical means, an electro restrictive polymer, piezoelectric material, or material adapted to contract when activated. One skilled the art will recognise that there are many options available for material within the actuating means. The electromechanical means can comprise an electric motor or solenoid for example. However, for purposes of describing this invention, it will be discussed in terms of the material adapted to contract when activated. Preferably, this material adapted to contract when activated is a shape memory alloy wire. Shape memory alloys are known and are usually made predominantly or wholly of titanium and nickel. They may also include other material, such as aluminium, zinc and copper. A shape memory alloy is capable of adopting one shape below a predetermined transition temperature (Martensitic) and changing to a second shape once its temperature exceeds the transition temperature (Austenitic). Conversely, when the shape memory alloy cools below the transition temperature, it is capable of adopting the first shape again. In connection with the preferred embodiments of the present invention, the shape memory alloy contracts when heated in situ. Shape memory alloy wire currently available, such as that sold under the name Nitinol, is capable of contracting when activated by heating. For longevity, it is preferred that the contraction is limited to about 3%.

Activation of shape memory alloy (SMA) such as Nitinol is preferably achieved through electrical resistance heating.

The actuating means may be powered in any suitable way, including by hard wiring and by battery. The actuating means may be activated in any suitable way. Non-limiting examples are pressing a button, entering a code on a keypad or using a key. The actuating means may be activated remotely. Preferably, in this embodiment, the actuating means is activated by radio frequency devices.

The lock assembly of the invention preferably includes retaining means for retaining the bolt in the unlocked position. For example, in the embodiment where the bolt has at least s one cavity, the retaining means may be adopted to at least partially enter that cavity once the bolt has been moved to the unlocked position and thus retain the bolt in that position. In a second embodiment, where the bolt does not include such a cavity, the retaining means may be designed to hold back the blocking means (against its bias to the blocking position, if the bias is present). In either case, it is preferred that the retaining means can be actuated to lock the blocking means or the bolt, such that the bolt is either in the unlocked postion or free to move between the locked and unlocked positions, by actuating means including material adapted to contract when activated, as described above.

The lock assembly of the invention may include a relief spring adapted to allow the handle (if present) to rotate when the bolt is in the locked position, even though in this situation the handle will not move the bolt to the unlocked position.

In an especially preferred embodiment, the assembly of the invention includes manual release means for enabling movement of the bolt from the locked position.

In one embodiment, the manual release means moves the blocking means away from the position where it blocks movement of the bolt in the locked position. The blocking means may be spring loaded towards the position where it blocks movement of the bolt in the locked position. The manual release means may enable the blocking means to be retracted against the bias of the spring, so that the bolt is no longer blocked from retracting from the locked position.

The manual release means, if included in the lock assembly of the invention, may be operable from either side of the lock assembly or from both sides. For example, the manual release means may be operable from inside a room or passageway closed by a door having an embodiment of the lock assembly. Where the lock assembly is operable by a key pad, the key pad may include a facility for manual release.

The manual release means may be activated manually, or by remote activation, or electronically. In the last-mentioned situation, the manual release means is more of an override than a true manual release. Remote activation may take place by a suitable signal to a receiver in the manual release means. For example, the manual release may respond to a radio signal, ultrasound, use of a magnetic or electromagnetic field. Other remote activation methods are within the scope of the invention.

### BRIEF DESCRIPTION OF THE DRAWINGS

The invention will now be described in connection with the following non-limiting embodiments in the accompanying drawings, in which:

FIG. 1 is a plan view of a first embodiment of the lock assembly of the present invention;

FIG. 2 is a perspective view showing internal components of the lock assembly of FIG. 1;

FIG. 3 is a plan view showing blocking means used in the lock assembly;

FIGS. 4(a), (b) and (c) are plan views showing internal components of the lock assembly of FIG. 2 in various positions;

FIG. 5 is a plan view of the lock assembly of FIG. 4(b) but with manual release activated;

FIG. 6 is is a plan view of a second embodiment of the lock assembly of the present invention;

FIGS. 7(a), (b) and (c) are plan views showing internal components of the lock assembly of FIG. 6 in various positions;

FIG. 8(a) is a view of a third embodiment, similar in many respects to the first embodiment in FIGS. 1 to 5, in perspective, partially exploded view, from one side;

FIG. 8(b) shows the embodiment of FIG. 8(a) from the other side;

FIG. 9 is a perspective view showing internal components of the lock assembly of FIGS. 8(a) and 8(b);

FIG. 10 is a perspective view showing internal components of the blocking cartridge for the embodiment in FIGS. 8 and 9;

FIG. 11 shows a detail from part of the view of FIG. 8(b), at a slightly different angle, and showing a detail of manual release; and

FIG. 12 shows a component of the FIG. 11 view, being a manual release cam mechanism.

### DETAILED DESCRIPTION OF THE INVENTION

It will be readily appreciated that the views in the various Figures are not all drawn to the same scale.

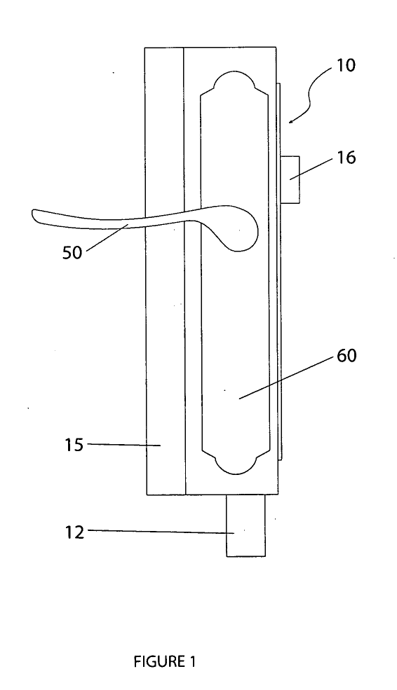

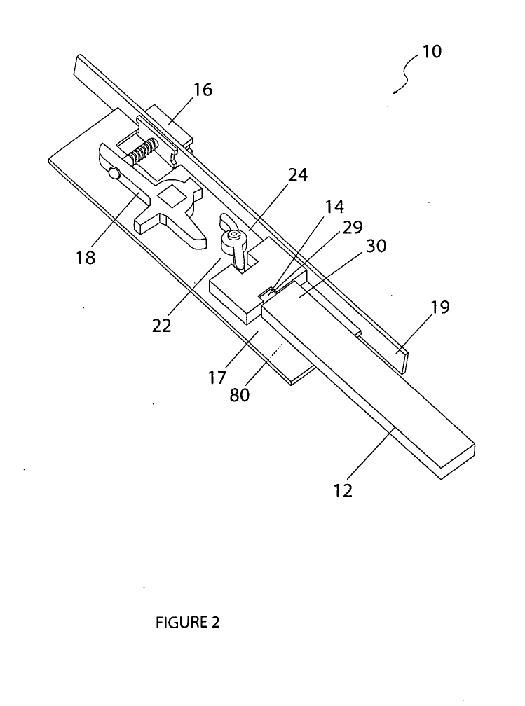

Turning to the Figures generally and to FIG. 1 in particular, there is shown lock assembly 10 having handle 50 rotatably mounted in support base 80 (not shown in FIG. 1, but see FIG. 2). Handle 50 is adapted to rotate to release latch 16 to open a door. Blocking cartridge 12 is shown projecting from panel 15.

In FIG. 2, locking assembly 10 is shown with blocking cartridge 12, bolt 14, levers 18, 22, springs 20, 24 and latch 16. Lever 18 is connected to handle 50 (not shown). Blocking cartridge 12 is shown having retaining means 30 received by cavity 29 of bolt 14, preventing bolt 14 from moving from the unlocked position illustrated to the locked position in which bolt 14 would extend from the support base. The support base in this embodiment comprises backing plate 17 and side plate 19, at a right angle to backing plate 17.

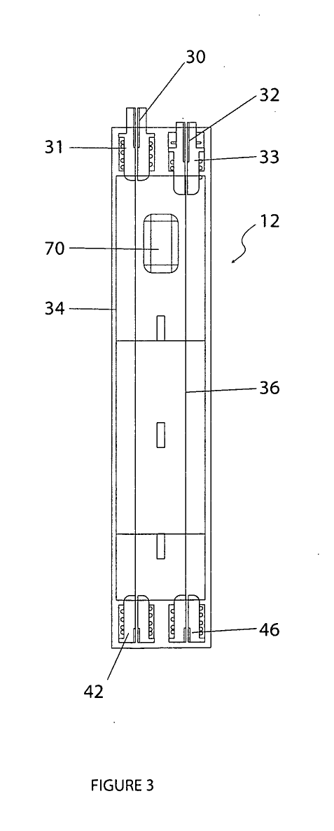

Blocking cartridge 12 shown in FIGS. 3 to 5 has blocking means 32 and retaining means 30 connected to actuating means 46 and 42, respectively, by shape memory alloy (SMA) wires 36 and 34, respectively. Blocking means 32 and retaining means 30 are biased towards the position shown by retaining means 30 in FIG. 3, by torsion springs 33 and 31, respectively. When actuating means 42 is activated, SMA wire 34 contracts and pulls down retaining means 30 against the bias of spring 31. When actuating means 46 is activated, SMA wire 36 contracts and pulls down blocking means 32 against the bias of spring 33.

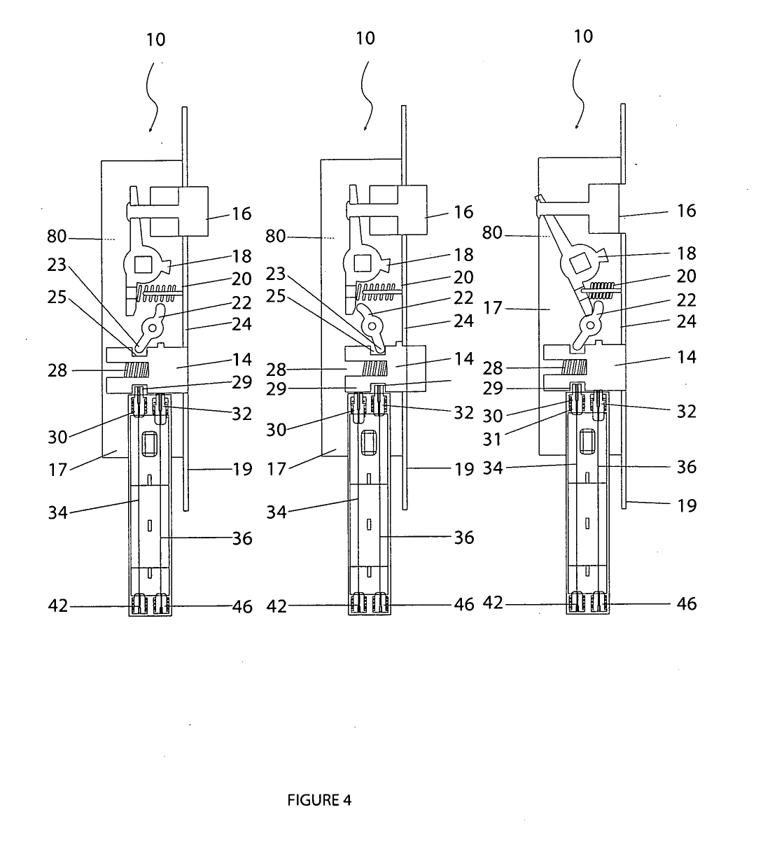

FIG. 4(b) shows lock assembly 10 in the locked position, with bolt 14 extending from support base 80 and blocked against withdrawal by blocking means 32. Retaining means 30 is being held down by the bottom part of bolt 14. Latch 16 is in the closed position. Levers 18, 22 form a levering mechanism. When actuating means 46 is activated, SMA wire 36 contracts and pulls blocking means 32 out of cavity 29 to free bolt 14. Within a pre-determined time, when handle 50 (not shown) is turned, lever 18 pivots and in turn rotates lever 22 to move bolt 14 from the locked position to the unlocked position, as shown in FIG. 4(c). Retaining means 30 is pushed up by torsion spring 31 and received by cavity 29 when bolt 14 is in the unlocked position. Handle 50 also causes latch 16 to be retracted within support base 80 to allow the door to open.

If handle 50 is not turned within the pre-determined time, SMA wire 36 will cool and extend and blocking means 32 will be pushed up again by torsion spring 33, holding bolt 14 in the locked position.

Alternatively, actuating means 46 may continue to be activated, which would keep SMA wire 36 in the contracted form, and there would be no time limit for turning handle 50.

As shown in FIG. 4(a), when handle 50 is released and pushed back to the original position by spring 20, latch 16 returns to the closed position. Bolt 14 remains in the unlocked position, being blocked by retaining means 30.

To change to the locked position, actuating means 42 is activated. SMA wire 34 contracts and pulls down retaining means 30. Bolt 14 is now freed and pushed by torsion spring 28 to the locked position. This in turn causes lever 22, which has end 23 inserted in cavity 25, to pivot, assisted by the influence of spring 24, to the position shown in FIG. 4(b). While in the locked position, if handle 50 is turned with excessive force, lever 22 vill not pivot but will be pushed forward, compressing spring 24. This allows handle 50 to rotate, but the door remains locked.

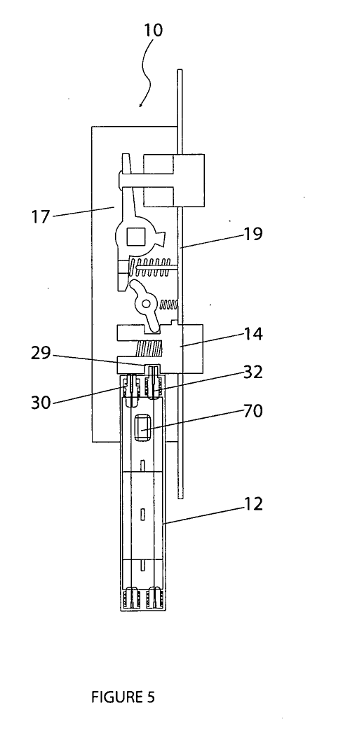

Lock assembly 12 can be manually unlocked in case of failure of blocking cartridge 12. A small screwdriver can be inserted into manual release hole 70 of blocking cartridge 12 (shown in FIG. 3) through hole 60 of lock assembly 12 (shown in FIG. 1) and pulled down to move entire blocking cartridge 12 down, causing blocking means 32 to move out of cavity 29, as shown in FIG. 5. Bolt 14 is now free to move. When handle 50 is turned, bolt 14 moves to the unlocked position in the usual manner described above.

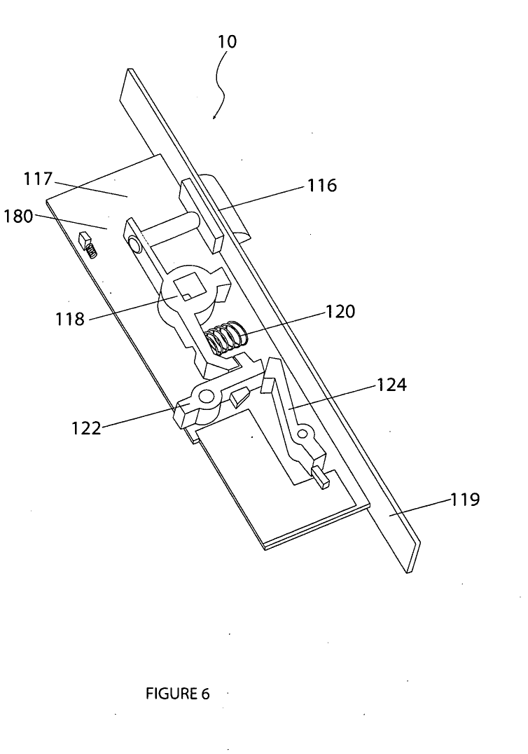

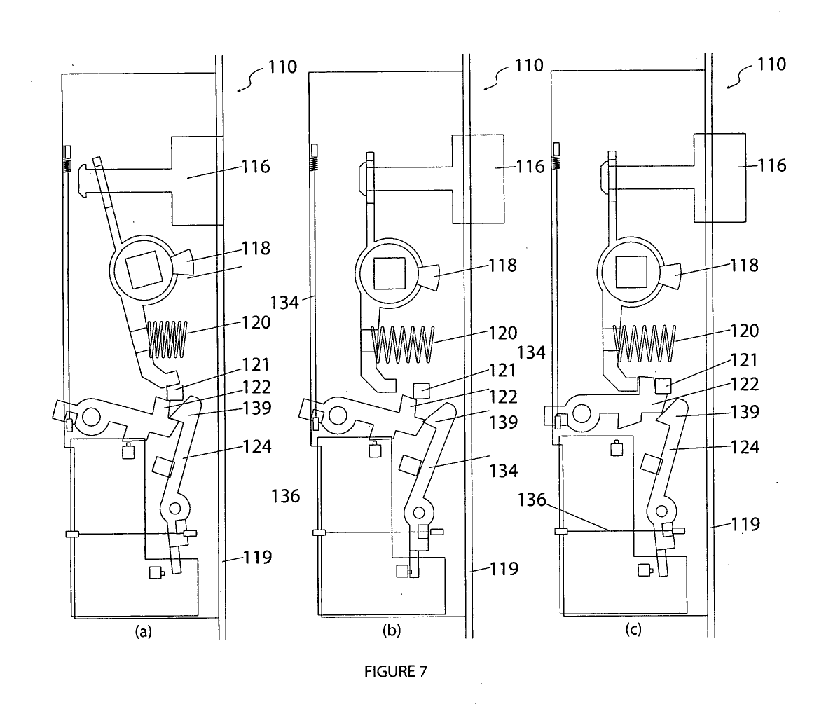

Now turning to the second embodiment of the invention shown in FIGS. 6 and 7, lock assembly 110 has retaining means 124, blocking means 122, and lever means 118 biased to a pre-determined position by torsion spring 120, on support base 180. A handle (not shorten) is adapted to rotate lever means 118 to release latch bolt 116 to open a door, unless lever means 118 is blocked by blocking means 122, as shown in FIG. 6.

In FIG. 7(a), locking assembly 110 is in an unlocked position with the handle (not shown) having been turned. This has caused lever means 118 to rotate until it reaches stop 121. Torsion spring 120 is thus compressed. Blocking means 122 is retained by pawl 139 of retaining means 124. Retaining means 124 is biased to this retained position by a torsion spring (not shown).

To latch the door, the handle (not shown) is released to allow lever means 118 to be biased by torsion spring 120 to return to the pre-determined position, extending latch bolt 116 from side plate 119, as shown in FIG. 7(b). In this position, blocking means 122 continues to be retained by pawl 139 of retaining means 124 and locking assembly 110 can be used in passage mode.

To lock the door, SMA wire 136 is activated and contracts, pulling retaining means 124 to release blocking means 122. Blocking means 122 is pushed up by a torsion spring (not shown) to engage with lever means 118, preventing lever means 118 from moving, as shown in FIG. 7(c). Now the handle cannot be turned, retaining latch bolt 116 in the locked position.

To unlock the door, SMA wire 134 is activated, pivoting blocking means 122 away from lever means 118. While blocking means 122 is being pulled down, blocking means 122 travels past pawl 139 of retaining means 124 until blocking means 122 is locked/retained by pawl 139, as shown in FIG. 7(a). Now the handle can be turned to open the door, in the manner referred to above.

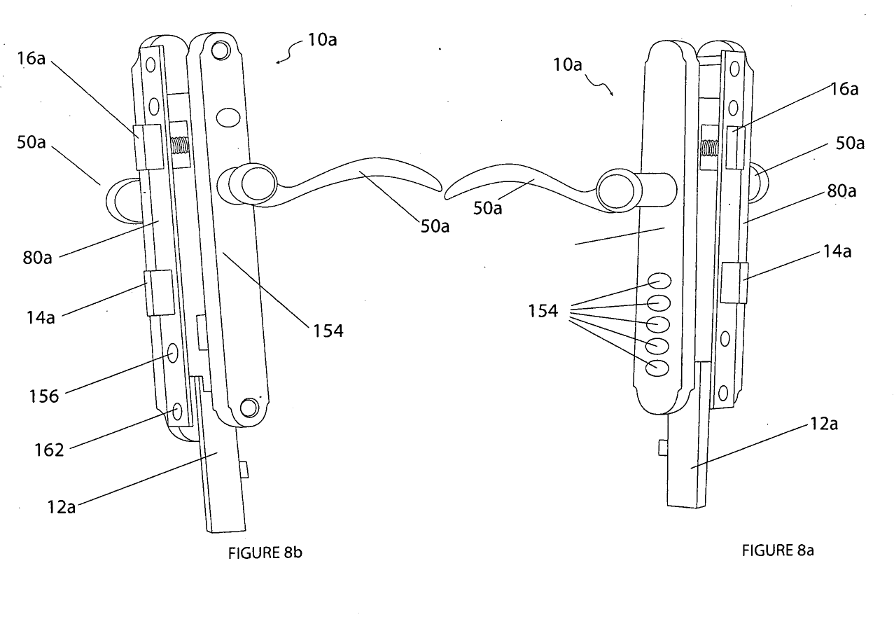

Turning now to the third embodiment of the invention in FIGS. 8 to 12, this is in many respects similar to the first embodiment in FIGS. 1 to 5. To indicate similar parts, the same labels will be used as those used in reference to FIGS. 1 to 5, with the addition of the letter “a”.

As can be seen from FIGS. 8(a) and 8(b), lock assembly 10a has handle 50a rotatably mounted in support base 80a. Handle 50a can be rotated from either side of lock assembly 10a to release latch 16a to open a door (not shown) on which lock assembly 10a is mounted.

FIG. 8(a) shows lock assembly 10a from the outside of the door, while FIG. 8(b) shows lock assembly 10a from the inside of the door. Push buttons 150 are shown in FIG. 8(a). Push buttons 150 are used to enter an allocated entry code to trigger unlocking of bolt 14a, using a very similar mechanism to that described in connection with FIGS. 1 to 5. Push buttons 150 are mounted in panel 15a.

Blocking cartridge 12a is shown projecting below lock assembly 10a. It will be appreciated that blocking cartridge 12a will normally be installed within the door (not shown).

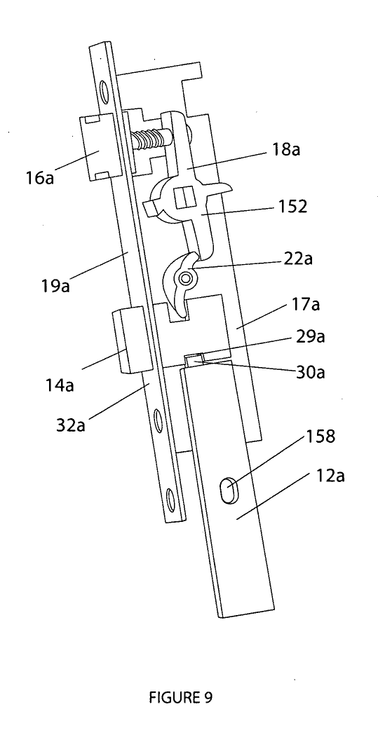

FIG. 9 shows the mechanism of lock assembly 10a with part only of blocking cartridge 12a visible.

As with the first embodiment, the support base comprises backing plate 17a and side plate 19a. Levers 18a and 22a are similar to levers 18 and 22 in the first embodiment, although not identical. Spring 20 of the first embodiment is replaced by spring 152 in FIG. 9.

Bolt 14a includes cavity 29a for receiving (in this illustration) locking means 32a. Retaining means 30a can be discerned, maintained in the retracted position by the base of bolt 14a.

The manual release mechanism in the third embodiment will now be described.

As may be seen in FIG. 8(b), face plate 154 is connected to blocking cartridge 12a through manual release cam 156. Manual release cam is shown on its own in FIG. 12. Blocking cartridge 12a has an oval aperture 158 (FIG. 9) for securing cam 156.

As the detailed view in FIG. 11 shows, cam 156 has projection 160 which mates with a ledge around aperture 158 in a normal situation. If it is desired to activate the manual release, grooved thumb plate 162 on cam 156, which is set into the base of face plate 154, is rotated to turn cam 156 so that projection 160 no longer contacts the ledge of aperture 158. Blocking cartridge 12a is spring loaded away from bolt 14a. Consequently, when the ledge of aperture 158 is no longer constrained by projection 160 of cam 156, blocking cartridge 12a moves away from bolt 14a to the limit permitted by the shape of aperture 158, until cam 156 reaches the upper limit of aperture 158.

This movement away from bolt 14a is sufficient to allow locking means 32a to clear cavity 29a, freeing bolt 14a.

If desired, lock assembly 10a may be set up so that manual release can be achieved through use of buttons 150.

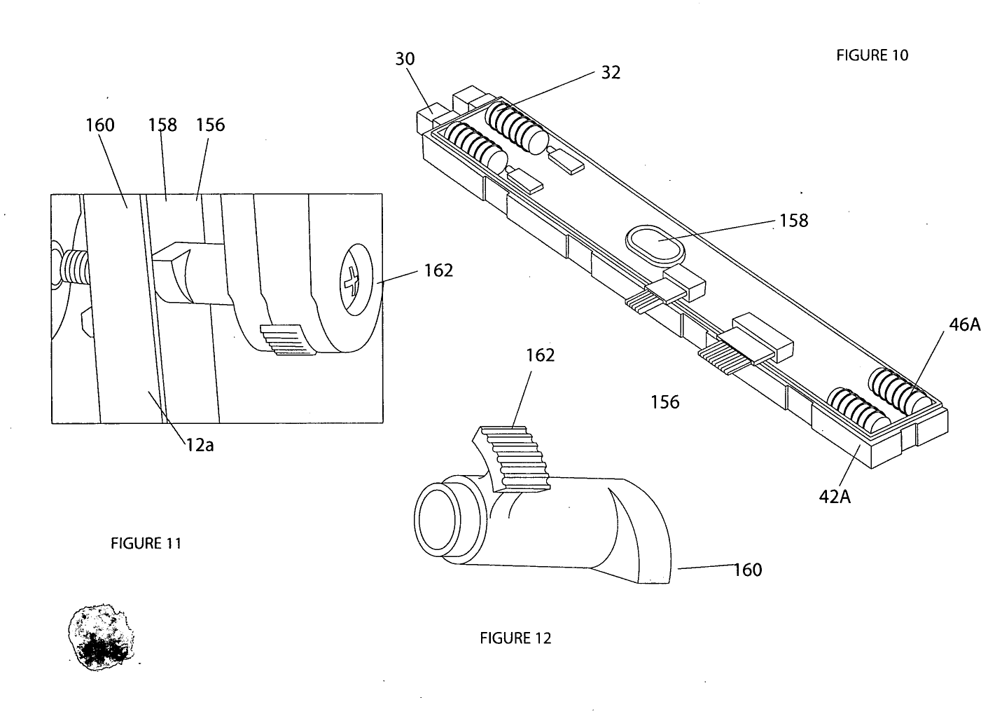

In relation to FIG. 10, this is similar in layout to the view in FIG. 3, except that aperture 158 is included for the purposes of the manual release mechanism.

It will be appreciated by one skilled in the art that various changes may be made to the embodiments of the invention without departing from the spirit and scope of the invention.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

1. A lock assembly including a support base, a bolt moveable between an unlocked position in which the bolt is substantially within the support base and a locked position in which the bolt extends from the support base, blocking means to block movement of the bolt in the locked position and actuating means for moving the blocking means to release the bolt from the locked position, the actuating means comprising electromechanical means, an electro restrictive polymer, piezoelectric material or a material adapted to contract when activated.

2. The lock assembly of claim 1 which includes a tongue or latch operable by a handle rotatable in relation to the support base.

3. The lock assembly of claim 1 wherein the bolt is operable by a handle rotatable in relation to the support base when the bolt is not locked by the blocking means.

4. The lock assembly of claim 1, wherein the bolt is biased to the locked position.

5. The lock assembly of claim 4, wherein the bolt includes at least one cavity and the blocking means is adapted to at least partially enter the cavity to block movement of the bolt in the locked position.

6. The lock assembly of claim 1, wherein the blocking means includes a catch for blocking a lever adapted to retract the bolt from the locked position.

7. The lock assembly of claim 6, wherein the catch is biased towards blocking the lever.

8. The lock assembly of claim 1, wherein the actuating means is adapted to respond to pressing a button, the entry of a code on a keypad, the use of a key or remote activation.

9. The lock assembly of claim 8, wherein the actuating means comprises material adapted to contract when activated in the form of a shape memory alloy wire.

10. The lock assembly of claim 8, wherein the actuating means comprises electromechanical means in the form of an electric motor or solenoid.

11. The lock assembly of claim 1, wherein the actuating means is adapted for remote activation by radio frequency device.

12. The lock assembly of claim 1, which includes retaining means for retaining the bolt in the unlocked position.

13. The lock assembly of claim 12, wherein the bolt has at least one cavity and the retaining means is adapted to at least partially enter the cavity when the bolt is in the unlocked position.

14. The lock assembly of claim 12, wherein the retaining means is adapted to hold back the blocking means.

15. The lock assembly of claim 13, which includes second actuating means for actuating the retaining means to retain the bolt in the unlocked position, the second actuating means comprising electromechanical means, an electro restrictive polymer, piezoelectric material or a material adapted to contract when activated.

16. The lock assembly of claim 14, which includes second actuating means for actuating the retaining means to retain the bolt in the unlocked position, the second actuating means comprising electromechanical means, an electro restrictive polymer, piezoelectric material or a material adapted to contract when activated.

17. The lock assembly of claim 1, which includes manual release means for enabling movement of the bolt from the locked position.

18. The lock assembly of claim 17, wherein the manual release means is adapted to move the blocking means away from the position where it blocks movement of the bolt in the locked position.

19. The lock assembly of claim 18, wherein the manual release means is adapted for activation manually, by remote activation or electronically.

20. The lock assembly of claim 19, wherein the manual release means includes a receiver for enabling the manual release means to respond to a radio signal, ultrasound, or use of a magnetic or electromagnetic field.

21. The lock assembly of claim 1, when installed in a door.

22. A door including the lock assembly of claim 1.
